(19) United States
(12) Patent Application Publication
(10) Pub. No.: US 2019/0232909 A1
(43) Pub. Date: Aug. 1, 2019

(54) SEAT BELT STATUS MONITORING SYSTEM

(71) Applicant: IEE INTERNATIONAL ELECTRONICS & ENGINEERING S.A., Echternach (LU)

(72) Inventors: Laurent LAMESCH, Reichlange (LU); Michael PUETZ, Trier (DE); Tobias JUSTINGER, Konz (DE)

(21) Appl. No.: 16/340,956

(22) PCT Filed: Oct. 6, 2017
(86) PCT No.: PCT/EP2017/075453

§ 371 Date: Apr. 10, 2019

(30) Foreign Application Priority Data
Oct. 13, 2016 (LU) 93261

(51) Int. Cl. B60R 21/015; B60N 2/00; B60R 22/48

(52) U.S. Cl. CPC B60R 21/01546; B60R 21/01526; B60R 2021/01088; B60R 22/48; B60N 2/002

(57) ABSTRACT

A seat monitoring system for monitoring an occupancy related status of at least one seat inside an automotive vehicle compartment. The seat monitoring system includes a control module mounted within the compartment, and at least one sensor module integrated into the at least one seat. The sensor module has a sensing system for sensing an occupancy related status with respect to the seat. The control module is arranged in wireless communication with the sensor module. The control module has at least three transmitting RF antennas configured to transmit a request signal in at least three directions inside the vehicle compartment; and the sensor module is further configured to receive the request signals from the at least three directions, to determine reception parameters of the request signals, and to transmit an information responsive to the reception parameters to the control module.

### TECHNICAL FIELD

The present invention relates generally to a seat belt status monitoring system, and more specifically to a seat belt status monitoring system for a seat inside an automotive vehicle comprising a plurality of seats installed on substantially arbitrary locations inside the vehicle.

### BACKGROUND OF THE INVENTION

Seat belt reminder systems are now common equipment in automotive vehicles and particularly in automobiles in order to remind a vehicle passenger to fasten his seat belt. As it is mandatory to have a seat belt for each passenger seat, even in the back of the vehicle, it is natural to have a seat belt reminder system for each seat, which will generate a signal at least visible to the driver.

Generally, seat belt reminder systems include sensors that associate the presence of an occupant with and the detection whether the latch of the seat belt is inserted into the seat belt buckle. The sensor then generates signals to a control unit. The control unit uses the signals in order to determine whether the actual seat occupancy would require a non-fastened seat belt to be fastened and accordingly issue a corresponding warning signal.

In parallel to the seat belt reminders developments, the automotive vehicles have also developed new solutions of interior arrangements. For example, arrangements where the back seats are easily installable and removable giving the possibility to alternatively use the vehicle to transport more passengers or to have a bigger trunk space for goods. In some vehicles, the rear seats are installed on racks or other systems giving them even more flexibility with the ability to be fixed on substantially arbitrary locations inside the vehicle.

Flexible vehicle interior arrangements create new constraints when installing seat belt reminder systems. Namely, any physical connection with cables between the seat belt reminder system and the vehicle is not any more desirable.

Solutions are known in art for wireless seat belt warning systems. For example in document DE 19919158 A1, the seat belts are equipped with reflecting reference dots, and the automobile comprises a seat belt monitor mounted to the ceiling and configured to measure a distance between said device and the reference dots of the seat belts. The measurement is done by optically locating the reflecting dots using the measuring device.

In the latter solution, the seat belts do not need to be equipped with an electrical device which removes any issue with cable connections or power supply. Nevertheless, the above solution is expensive to implement and optical measurements are easily disturbed by the passengers themselves when covering the reflecting dots, making the system unreliable by involving a great measurement error.

In another solution disclosed in DE 102007060317 A1, a seat belt sensing system is in wireless communication with an ECU fixed under the seat. The seat is hence removable without any problematic cable connection.

The drawback of this solution is that each seat needs to be equipped with a respective ECU. It results high production costs and a limited flexibility as the seats need to stay close enough to the ECU.

Other solutions disclosed in US 2004119599 A1 or U.S. Pat. No. 8,902,057 propose similar solutions involving the same drawbacks, namely a lack of flexibility and relatively high production costs.

In yet another prior art solution, document U.S. Pat. No. 7,639,125,B2, discloses a seat belt warning system comprising a sensing system associated to a vehicle seat for sensing a seat belt related status with respect to said vehicle seat and a control unit communicating with the sensing system. The control unit is configured to generate a warning signal determined by the sensing system when detecting an occupied seat where the seat buckle is in an unbuckled state. The sensing system further comprises a surface acoustic wave device including a surface acoustic wave resonator and an antenna and the control unit comprises a radio frequency antenna for remotely communicating with the surface acoustic wave device.

The system proposed in this prior art document allows having a wireless connection between the seat sensors and a single base unit. There is no necessity to have one base unit assigned to one single seat. But the recognition of the seat that is sending for example a message corresponding to a warning signal is only possible because the seats have a specified position related to one another. The flexibility of the system is here again limited and particularly in an automobile with interchangeable or randomly installable seats.

### SUMMARY

It is therefore desirable to provide a seat belt status monitoring system that improves the solutions disclosed in the state of the art, and particularly a seat belt status monitoring system that is reliable and highly flexible in relation with the seat arrangement inside the vehicle.

In various embodiments, the invention overcomes at least some of the above discussed deficiencies and disadvantages by providing a seat monitoring system for monitoring an occupancy related status of at least one seat inside an automotive vehicle compartment. The seat monitoring system comprises a control module mounted within the compartment, and at least one sensor module integrated into the at least one seat. The sensor module comprises a sensing system for sensing an occupancy related status with respect to the seat. The control module and the sensor module are configures and arranged such that the control module may wirelessly communicate with the sensor module.

According to at least some embodiments of the invention, the control module comprises at least three transmitting RF antennas configured and arranged so as to transmit a request signal in at least three directions inside the vehicle compartment. The sensor module is further configured to receive the request signals from the at least three directions, to determine reception parameters of said request signals, and to transmit an information responsive to said reception parameters to said control module.

Consequently, the sensor module receives at least three signals from three different directions and/or locations of the vehicle compartment, and is configured to determine reception parameters for each received signal. This information responsive to the reception parameter may further be computed to determine the location of the seat inside the vehicle compartment. In this way, even if the seat is placed in a random location inside the compartment, the seat monitoring system is able to identify which seat in the compartment is transmitting a signal, for example by knowing the position of the seat from where the signal is transmitted. It should be noted that the system is not limited to the use of unidirectional antennas. In fact, the system only requires that the request signal is transmitted from three different locations so that, from the perspective of the sensor module, the signals originate from different directions. Thus the used RF transmitting antennas can be omnidirectional without affecting the functionality of the system.

Using a wireless communication removes the need for cabling between the modules and consequently between the seat and the vehicle compartment. The seats may be placed in any location inside the vehicle compartment, giving a complete flexibility to the seats arrangement in the compartment.

A typical vehicle compartment comprises a plurality of seats. In that case, the monitoring system comprises one control module and a plurality of sensor modules with one sensor module being integrated into each seat in the compartment.

In embodiments, the reception parameters comprise intensities of the electromagnetic field transmitted by the request signals. The intensities of the signals being related to the distance from the transmitting source, it is therefore possible to determine the distance between the seat and each transmitting antenna.

The reception parameters may be any feature of the signal that distinguishes the direction and/or the distance between the sensor module and the transmitting antenna. The sensor module may comprise an element configured to store the reception parameters after each received request signal, for example a microcontroller or any suitable element.

The wireless communication between the control and sensor module may be assured by any suitable means, for example using transmitting and receiving radio frequency (RF) antennas in the control module and/or a remotely interrogatable surface acoustic wave device associated with the sensor module. Advantageously, the system uses both low frequency (LF) and high/ultra-high frequency RF antennas, depending on the complexity of the exchanged message.

Preferably, the at least three transmitting antennas are LF transmitting antennas. LF antennas are less costly than high frequency antennas, and efficient to transmit request signal containing simple message information.

Advantageously, the antennas are mounted in three different locations of the vehicle compartment, for example along three different edge walls of the compartment. The positions and orientations of the antennas are determined in such a way that the sensing module will be able to receive the signal transmitted by the antennas regardless of its location inside the vehicle compartment.

In preferred embodiments, the control module is configured to determine the seat location using the information transmitted by the sensor module.

In other embodiments, the sensor module is configured to determine the seat location using the reception parameters and to transmit said seat location in the information responsive to the reception parameters.

The message sent contains less information and the control module needs less computing power if the position is determined by the sensor module. When the control module is shared for other applications in the vehicle, this solution is advantageous as it removes a burden of computing power from the control module. Nevertheless, these embodiments require each sensor to comprise a computing means resulting in a costly system.

If the position is determined by the control module, the message sent to the control module carries more information which involves the use of at least HF antennas for communication. But this solution requires less computing means in each sensor module and is consequently more cost efficient than in the previously described embodiments.

Advantageously, determination of the location of the seat using the reception parameters may be performed through a typical triangulation method commonly known in the art. If more than three antennas are used to transmit the request signal, a triangulation method is repeated several times using different combinations of three received signals. This allows the system to determine the seat's location with a greater precision. This feature is useful in case the seats are randomly movable in the vehicle compartment and possibly fixed in compact arrangements like for example where two sensing module are in contact next to each other.

In embodiments, the occupancy related status comprises a seat belt buckle status, indicative of whether a seat belt of the seat is buckled or unbuckled.

In other embodiments, the occupancy related status comprises an occupancy status, indicative of whether an occupant is seated on the seat.

In a preferred embodiment of the invention, the seat occupancy related status comprises a combination of a seat belt buckle status and a seat occupancy status. These embodiments offer a better reliability of the seat occupancy related status. For example, the seat occupancy related status comprises two status of interest: a first status, when the seat is unoccupied or when the seat is occupied and the seat belt is buckled; and a second status when the seat is occupied and the seat belt is unbuckled.

In embodiments the sensing system only checks the occupancy related status when receiving a control request signal. This enables the sensing system to remain inactive when no request signal is received and save on battery power.

The sensor module may be configured to transmit the information responsive to the reception parameters and the occupancy related status in separate parts of the transmission information. In embodiments, the sensor module is configured to transmit the information responsive to the reception parameters only when the occupancy related status correspond to an unbuckled and occupied seat. Similarly to the above embodiments, the sensor module only performs a transmission when necessary, and remains partially inactive the rest of the time.

Preferably, the sensor module comprises a battery to supply power to the module.

The battery may be assisted in providing electrical power by using the signal received by the antenna to charge the battery or directly to supply an additional power to the system. Advantageously, the sensor module may comprise passive sensor devices that do not require a battery power.

In embodiments, the sensor module comprises a unique ID and the sensor module is configured to transmit the information indicative of the seat location to the control module only when receiving a control request signal comprising its unique ID.

Consequently, the control module may separately interrogate each sensor module using unique IDs, so when a sensor is not being interrogated, it remains inactive.

In embodiments, the sensor module further comprises a 3D coil antenna. This type of antenna has efficient receiving properties in all directions and permits more diversity in the placement of the at least three transmitting antennas of the control module

In embodiments, the control module is part of a “passive entry passive start” base control unit. A “passive entry passive start” system is used in some automotive vehicles in order to allow the user to unlock a vehicle door for example by approaching the vehicle while carrying a key fob. For example the door is automatically unlocked when the key fob is close enough to the vehicle. Such a system requires the vehicle to be equipped with a means to determine the distance between the key fob and the vehicle.

An example of a “passive entry passive start” is described in the document EP 1189306 A1. A “passive entry passive start” typically comprises a base control unit transmitting a request signal in a similar way of the control module of the seat monitoring system. Accordingly, various embodiments of the invention could be configured to use functionalities of the base control unit of a “passive entry passive start” system in order to perform the operations of the control module. In a vehicle that is already equipped with the “passive entry passive start” system this will result in a reduction of elements of the seat monitoring system can be achieved, offering a reduction of the system cost and implementation complexity.

### BRIEF DESCRIPTION OF THE DRAWINGS

Further details and advantages of the present invention will be apparent from the following detailed description of not limiting embodiments with reference to the attached drawing, wherein:

FIG. 1 is a schematic top view of a typical automobile interior compartment equipped with a system according to an embodiment of the invention.

FIG. 2 is a layout of an embodiment of a sensor module circuit according to the invention.

FIG. 3 is a layout of an embodiment of a control module circuit according to the invention.

### DESCRIPTION OF PREFERRED EMBODIMENTS

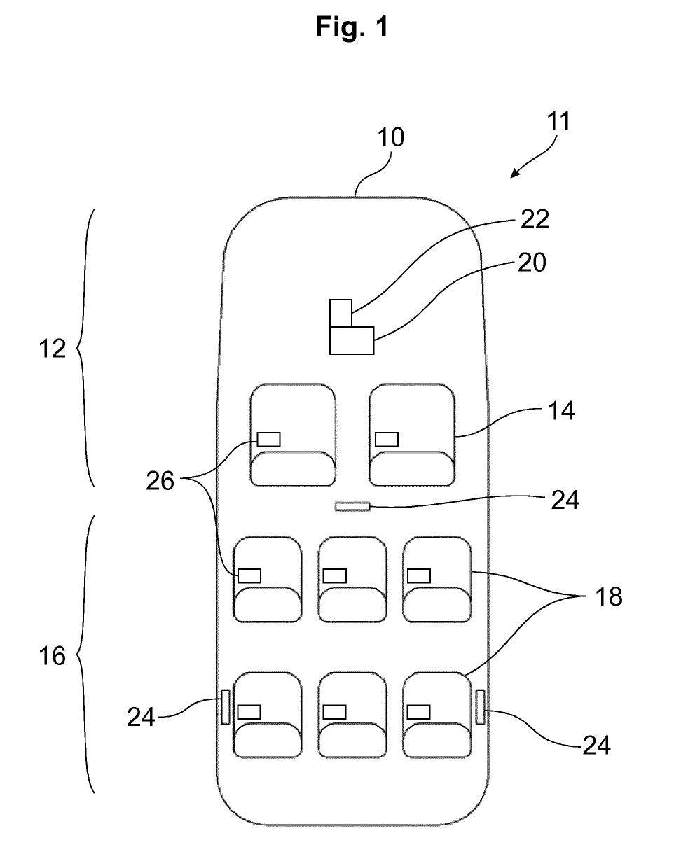

FIG. 1 schematically illustrates an interior compartment of a vehicle 10 equipped with a seat monitoring system 11 according to an embodiment of the invention. The compartment comprises a front part 12 with two front seats 14, and a rear part 16 where six rear seats 18 are arranged. Here the rear seats 18 are arranged on two lines of three seats, but it is understood that the rear seats 18 are movable and interchangeable.

The rear seats 18 are mounted on fixing means not shown that allow them to be fixed at substantially random positions inside the compartment 10. For example the rear seats may be mounted on rails allowing them to be movable in the entire length of the compartment, resulting in arrangements that are not necessarily following straight lines relative to the width of the vehicle.

The vehicle compartment further comprises a control module 20 preferably located in the front part of the vehicle. The control module 20 is connected to a display system 22 of the vehicle that is at least visible to the driver. The display system 22 is configured to display a warning indicating the location of a seat 14, 18 with a passenger who has not buckled his/her seat belt. Communication between the display system 22 and the control module 20 can be made by any suitable means or/and method.

The control module 20 is further connected to a plurality of radio frequency (RF) antennas 24 arranged in different locations inside the compartment 10. In the embodiment of FIG. 1, three antennas 24 are installed at different locations in the vehicle compartment. Two antennas 24 are located respectively on each lateral side of the rear part 16 of the vehicle 10, and one antenna 24 is located roughly in the center of the vehicle 10 between the front seats 14 and the rear sets 18.

All three antennas 24 are configured to transmit a signal towards the inside of the compartment. Preferably, the configuration of the antennas 24 allows the signal to be received at any location in the compartment 10. As represented in FIG. 1, two transmitting antennas are facing each other, and configured to transmit a signal in opposite direction, and the third antenna is transmitting in an orientation perpendicular to the others.

The RF antennas 24 are low frequency (LF) antennas, but it is understood than the RF antennas 24 may use any suitable frequency. In the following description, the RF antennas 24 will be indifferently called LF antennas 24. The frequency range of the LF transmission is between 5 kHz and 10 MHz, and more preferably lies within the 125 kHz industrial, scientific, and medical (ISM) radio band.

The LF antennas 24 are configured to send a LF signal to sensor modules 26 integrated into each of the front and rear seats 14, 18. Integration of the sensor module 26 may be made anywhere in the seat with the constraint that the sensor is secured to the seat. The sensor module 26 is configured to sense an occupancy related status of its respective seat and transmit it to the control module 20. Components of the sensor module 26 will be explained below.

The sensor module 26 is also configured to determine reception parameters from the signals sent by the LF antennas 24, and to further transmit a signal comprising information responsive to the reception parameters to the control module 20.

The control module 20 is configured to receive the signal comprising information responsive to the reception parameters, and to determine with the received information responsive to the reception parameters, the location of a seat on which a passenger is seated without having buckled his/her seat belt.

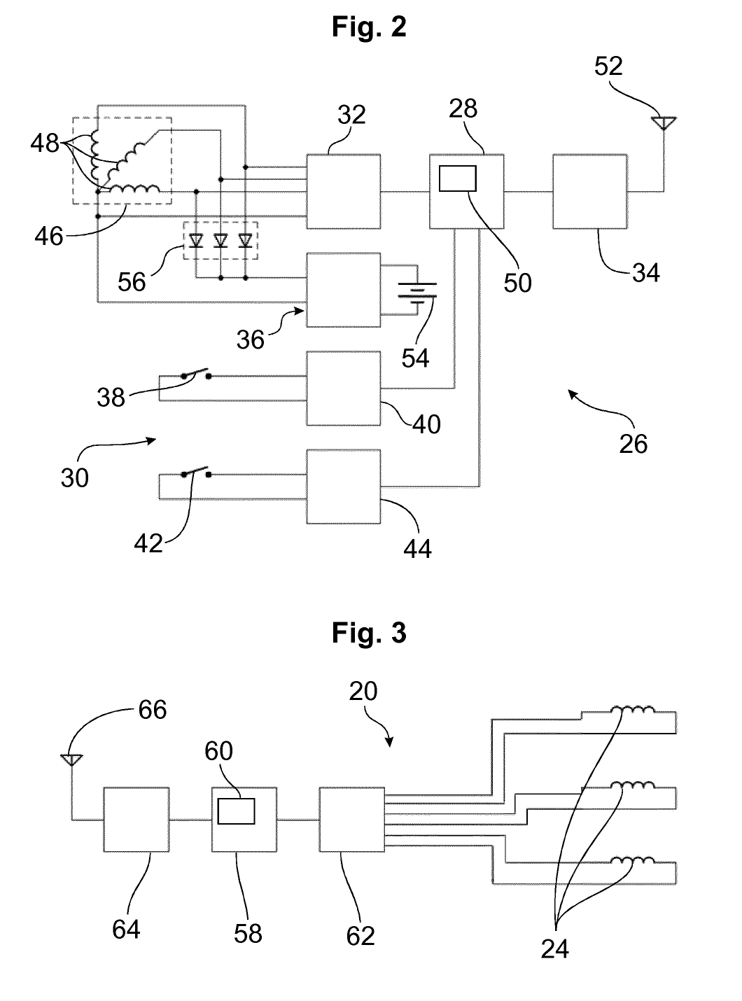

FIG. 2 shows a preferred embodiment of the components comprised in the sensor module 26 which is integrated into each seat 14, 18, in order to monitor seat occupancy related status. The seat occupancy related status may be any useful information the vehicle uses in relation with seat occupancy. Here the seat occupancy related status is the seat occupancy status, indicating whether the seat is occupied by a passenger, in combination with the seat belt buckle state, indicating whether the seat belt is buckled.

The sensor module 26 comprises a first control and evaluation system 28, connected to a sensing system 30, a request signal receiver 32, and a response signal transmitter 34. The sensor module 26 also comprises a power supply circuit 36 for supplying power to the other elements of the module 26.

The sensing system 30 comprises a buckle sensor 38, represented on FIG. 2 as a switch that is operable between an open position when the seat belt is unbuckled and a closed position when the seat belt is buckled. The sensing system 30 further comprises a buckle determination system 40 connected to the buckle sensor 38 and configured to send a signal to the seat control and evaluation system 28 indicative of the seat buckle state.

The sensing system 30 also comprises an occupancy sensor 42. The occupancy sensor 42 may be for example a capacitive sensor, an acceleration sensor or any sensor known in art to determine the occupancy state of the seat. On FIG. 2, the occupancy sensor 42 is represented by a switch operable between an open position when the seat is unoccupied and a closed position when the seat is occupied.

Similarly to the buckle sensor 38, the sensing system 30 comprises an occupancy determination system 44 connected to the occupancy sensor 42 and configured to send a signal to the seat control and evaluation system 28 indicative of the seat occupancy state.

The request signal receiver 32 is connected to a 3D coil LF antenna 46 with three receiving coils 48 which are physically oriented perpendicular to one another so as to form a trihedron.

The receiver 32 is further configured to demodulate a message modulated in the received request signal, and to measure the respective intensities of the request signal received by each of the three coils 48. The receiver 32 then sends the message along with the measured intensities to the first control and evaluation system 28.

The first control and evaluation system 28 further comprises a first microcontroller 50, which stores a unique ID corresponding to the sensor module 26, associated to the respective seat 14, 18. The first control and evaluation system 28 is also connected to the response signal transmitter 34, and the response signal transmitter 34 is connected to an ultra-high frequency (UHF) antenna 52 configured to send a response signal comprising modulated messages to the control module 20.

The Power supply circuit 36 uses the power from a battery 54 to supply the sensor module 26 with electrical energy. As shown in FIG. 2, a rectifier 56 rectifies the signal received by the 3D LF antenna 46, and supplies a rectified DC voltage to the power supply circuit 36. The power supply circuit 36 is further configured to charge the battery 54 with the electrical power received from the rectifier 56.

In embodiments, the electrical power received from the rectifier 56 is employed to directly supply power to the rest of the circuit in addition to the power from the battery 54, thereby reducing the power drain on the battery 54.

In embodiments, battery 54 is replaced by a capacitor which is charged by the electrical power received from the rectifier 56.

In operation, when a request signal containing a message is received by the 3D coil LF antennas 46, the LF receiver 32 demodulates the message modulated in the signal, and stores the intensities of the signals received by each coil 48 of the 3D antenna 46. The LF receiver 32 sends all the received information to the first control and evaluation circuit 28. The first microcontroller 50 in the first control and evaluation circuit 28 decodes the demodulated message sent by the LF receiver 32 and checks if the received message contains a seat status request and a unique seat ID. If a request and an ID corresponding to the seat ID stored into the first microcontroller 50 are contained in the request signal, the first microcontroller 50 requests the seat buckle and seat occupancy status sent to the buckle and occupancy determination systems 40, 44 and reads the determined status sent in response from the buckle and occupancy detection systems 40, 44. If the seat is occupied and the seat belt is not buckled, the first microcontroller 50 further reads the intensities of the signals received by the three coils 48 of the LF antennas 46. Then it determines the total received intensity by, for example, calculating the geometric or arithmetic mean of the three intensities. The received intensities are finally transmitted to the control module 20 via the transmitter 34 and the UHF antenna 52.

In embodiments, the first control and evaluation system 28 starts in a “stand-by state”, meaning that when the LF receiver 32 detects a magnetic LF field request signal from a vehicle LF antenna 24, the LF receiver 32 sends a signal to wake up the first microcontroller 50 of the first control and evaluation system 28, the following operations are then identical as described above.

As shown in FIG. 3, the control module 20 comprises a second control and evaluation system 58, comprising a second microcontroller 60 which controls a request signal LF transmitter 62 connected to the three LF antennas 24. The second microcontroller 60 stores a list of all the IDs of the front and rear seats 14, 18, included in the vehicle 10. The control module 20 further comprises a response signal receiver 64 connected to the second control and evaluation system 58, and to a UHF antenna 66.

Preferably, the frequency range of the UHF transmission is between 50 MHz and 10 GHz, and more preferably lies within one of the ISM bands of 443 MHz, 868 MHz, 915 MHz, 2.45 GHz, or 5.08 GHz.

In operation, the LF transmitting antennas 24 sequentially transmit a request signal comprising a modulated message through each of the LF antenna 24. The modulated message comprises a seat occupancy related status request associated with a seat ID selected in the list of IDs included in the second microcontroller 60.

The transmitting sequence goes through all the antennas with one predetermined ID then switch to another ID. The sequence starts for example with a first antenna 24 transmitting a request signal comprising a message with the first ID in the list, then a second antenna 24 transmits the same request signal comprising the first ID in the list, and finally a third antenna 24 transmits the request signal comprising the first ID in list. Next, the same operations are repeated with the second ID in list and the third, and so on until the last ID in the list.

After each transmission, the second microcontroller 60 checks if a message is being received by the UHF receiver 64 through the UHF receiving antenna 66. As explained above, the sensor module 26 only transmits a message when the two following conditions are fulfilled: The received request signal comprises the unique ID corresponding to the sensor module 26 and hence to the seat into which the module 26 is integrated; and when the seat associated with the control module 26 is occupied and unbuckled.

Accordingly, all the signals received by the UHF antenna 66 from a sensor module 26 are indicative of a seat that is occupied and unbuckled. Upon receiving a message, the second microcontroller 60 reads the received intensities from the modulated message and stores them in memory. Once each of the intensities of a specific control module 26 corresponding to all the three LF transmitting antennas 24 have been received and stored, the second microcontroller 60 uses the stored intensities to determine the location of the corresponding seat inside the compartment 10. Determination of the location of the seat is done by triangulation. Triangulation is a common method used in the art to determine the source location of a transmitted signal, and it will not be explained here. It is also understood that determination of the location is not limited to triangulation methods but to any other method known in the art.

In embodiments, more than three antennas 24 are installed. In that case triangulation is applied several times, and for example the mean or median location is used as location of the seat.

In embodiments, the vehicle compartment already comprises a “passive entry passive start” system is used to allow a user to open a door or a trunk without hand by only approaching the vehicle carrying a fob key. Such a system is configured to detect the position of the key fob and activate one or more functionalities when the key fob is close enough to the vehicle. A skilled person will observe that most of the components from FIG. 3 are already comprised in the “passive entry passive start” control module as it is commonly used in certain automobile vehicle. In these embodiments, the system according to the invention uses the same sensor module as described above in communication with the “passive entry passive start” module already existing in the vehicle. These embodiments permit to reduce the diversity of the components of the system and thus reduce overall cost

1. Seat monitoring system for monitoring an occupancy related status of at least one seat inside an automotive vehicle compartment, the seat monitoring system comprising a control module mounted within the compartment, and at least one sensor module integrated into the at least one seat, the sensor module comprising a sensing system for sensing an occupancy related status with respect to the seat, wherein said control module is arranged in wireless communication with said sensor module;
wherein the contol module comprises at least three transmitting RF antennas configured to transmit a request signal in at least three directions inside the vehicle compartment; and
wherein the sensor module is further configured to receive the request signals from the at least three directions, to determine reception parameters of said request signals, and to transmit an information responsive to said reception parameters to said control module.

2. Seat monitoring system according to claim 1, wherein the reception parameters comprise intensities of the electromagnetic field transmitted by the request signal sent from each of the at least three transmitting RF antennas.

3. Seat monitoring system according to claim 1, wherein the control module is configured to determine the seat location using the information transmitted by the sensor module.

4. Seat monitoring system according to claim 1, wherein the sensor module is configured to determine the seat location using the reception parameters and to transmit said seat location in the information responsive to the reception parameters.

5. Seat monitoring system according to claim 1, wherein the occupancy related status comprises a seat belt buckle status.

6. Seat monitoring system according to claim 1, wherein the occupancy related status comprises an occupancy status.

7. Seat monitoring system according to claim 1, wherein the occupancy related status comprises a combination of a seat belt buckle status and an occupancy status.

8. Seat monitoring system according to claim 1, wherein, the sensing system determines the occupancy related status only when receiving a control request signal.

9. Seat monitoring system according to claim 1, wherein the sensor module is configured to transmit the information responsive to the reception parameters and the occupancy related status in separate parts of a transmission information.

10. Seat monitoring system according to claim 1, wherein the sensor module is configured to transmit the information responsive to the reception parameters only when the occupancy related status corresponds to an unbuckled and occupied seat.

11. Seat monitoring system according to claim 1, wherein the sensor module comprises a unique ID and the sensor module is configured to transmit the information indicative of the seat location to the control module only when receiving a control request signal comprising its unique ID.

12. Seat monitoring system according to claim 1, wherein the sensor module comprises a 3D coil antenna.

13. Seat monitoring system according to claim 1, wherein the control module is part of a “passive entry passive start” base control unit.
